(19) United States
(12) Patent Application Publication
(10) Pub. No.: US 2006/0032355 A1
(43) Pub. Date: Feb. 16, 2006

(54) Cutting device for dual-blade cutting tool

(76) Inventor: Wang Tien Wang, Taichung County (TW)

Correspondence Address: CHARLES E. BAXLEY, ESQ., 90 JOHN STREET, THIRD FLOOR, NEW YORK, NY, 10038, US

(21) Appl. No.: 10/916,567

(22) Filed: Aug. 11, 2004

(51) Int. Cl. B27B 5/00

(52) U.S. Cl. 83/471.1; 83/477.2; 83/863

(57) ABSTRACT

A cutting device includes a fixing seat, a crank axle pivotally mounted on the fixing seat by a pivot shaft, a first saw blade mounted on the pivot shaft, a second saw blade mounted on the crank axle to move therewith, a motor mounted on the crank axle, and an adjusting unit mounted between the fixing seat and the crank axle to drive the crank axle to move relative to the fixing seat. Thus, the adjusting unit is operated to drive the crank axle to pivot, so that the second saw blade mounted on the crank axle is moved downward or upward, thereby adjusting the height of the second saw blade relative to the first saw blade so as to fit workpieces of different thickness.

### BACKGROUND OF THE INVENTION

1. Field of the Invention

The present invention relates to a cutting device for a dual-blade cutting tool, and more particularly to a cutting device having a simplified construction, thereby decreasing the costs of fabrication.

2. Description of the Related Art

A conventional dual-blade cutting tool comprises a base, a table mounted on a top of the base to move therewith. The table includes a housing, a cutting device mounted in the housing, and a motor mounted in the housing for driving the cutting device. The cutting device includes a plurality of rollers and two saw blades. The rollers are driven by the motor to drive the two saw blades to cut a workpiece, such as a wood material or the like.

### SUMMARY OF THE INVENTION

The primary objective of the present invention is to provide a cutting device, wherein the adjusting unit is operated to drive the crank axle to pivot, so that the second saw blade mounted on the crank axle is moved downward or upward, thereby adjusting the height of the second saw blade relative to the first saw blade so as to fit workpieces of different thickness.

Another objective of the present invention is to provide a cutting device, wherein the motor can be moved relative to the crank axle, so that the belt mounted on the motor can be loosened and removed from the output end of the motor, thereby facilitating the user replacing the belt.

A further objective of the present invention is to provide a cutting device, wherein the second pivot shaft has an eccentric structure, so that the second roller mounted on the second pivot shaft is driven to move relative to the drive belt by rotation of the second pivot shaft, thereby detaching the second roller from the drive belt, thereby facilitating the user replacing the drive belt.

In accordance with the present invention, there is provided a cutting device, comprising:
a fixing seat;
a crank axle pivotally mounted on the fixing seat by a pivot shaft;
a first saw blade mounted on the pivot shaft;
a second saw blade mounted on the crank axle to move therewith;
a motor mounted on the crank axle; and
an adjusting unit mounted between the fixing seat and the crank axle to drive the crank axle to pivot about the pivot shaft and to move relative to the fixing seat.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a cutting device in accordance with the preferred embodiment of the present invention;

FIG. 2 is a perspective view of the cutting device in accordance with the preferred embodiment of the present invention;

FIG. 3 is a perspective view of the cutting device in accordance with the preferred embodiment of the present invention;

FIG. 4 is a plan view of the cutting device in accordance with the preferred embodiment of the present invention;

FIG. 5 is a schematic operational view of the cutting device as shown in FIG. 4;

FIG. 6 is a plan view of the cutting device in accordance with the preferred embodiment of the present invention;

FIG. 7 is a schematic operational view of the cutting device as shown in FIG. 6;

FIG. 8 is a plan view of the cutting device in accordance with the preferred embodiment of the present invention; and

FIG. 9 is a schematic operational view of the cutting device as shown in FIG. 8.

### DETAILED DESCRIPTION OF THE INVENTION

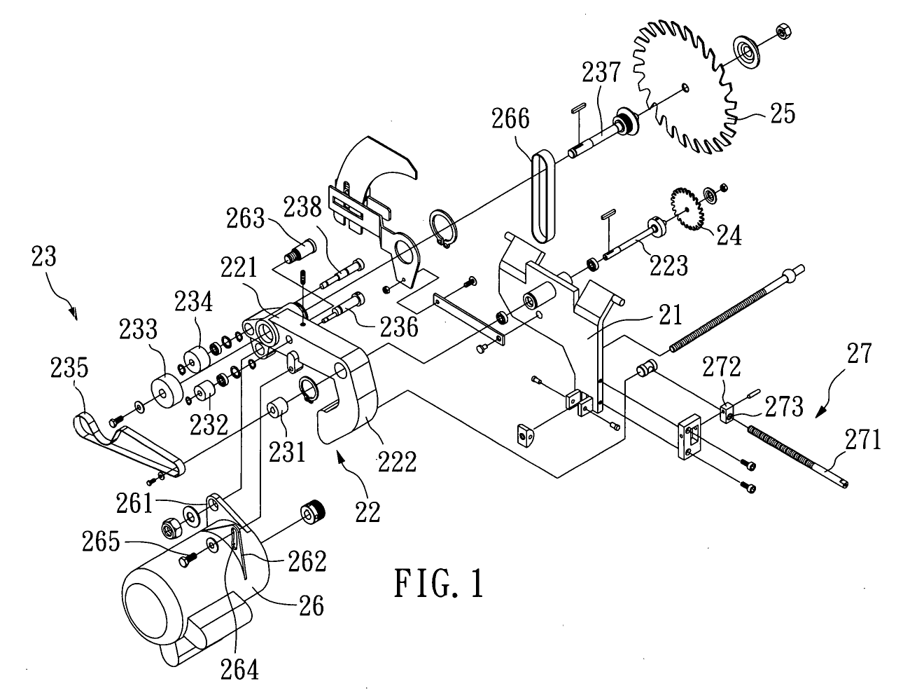

Referring to the drawings and initially to FIGS. 1-4, a dual-blade cutting tool in accordance with the preferred embodiment of the present invention comprises a base (not shown), a table (not shown) mounted on a top of the base to move therewith. The table includes a housing (not shown), and a cutting device 20 mounted in the housing.

The cutting device 20 comprises a fixing seat 21, a crank axle 22, a drive unit 23, a first saw blade 24, a second saw blade 25, a motor 26, and an adjusting unit 27.

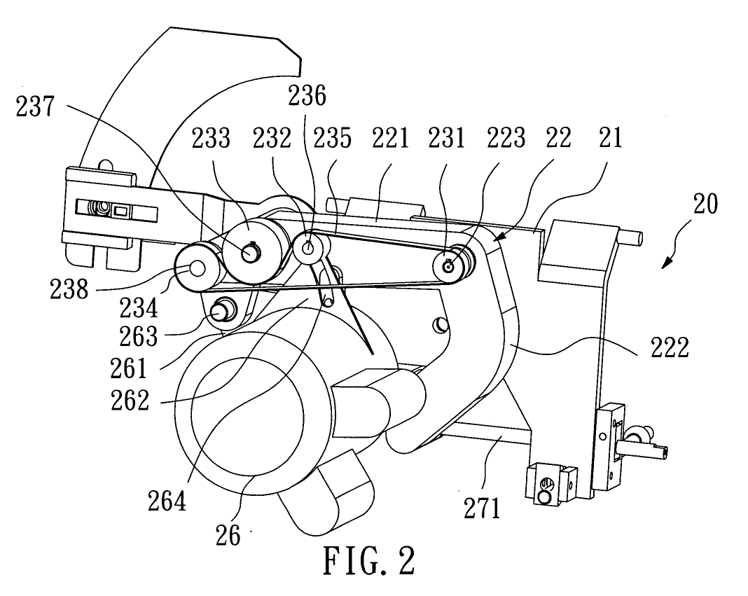

As shown in FIGS. 1 and 2, the fixing seat 21 has a plate shape.

The crank axle 22 is pivotally mounted on a side of the fixing seat 21. The crank axle 22 is substantially L-shaped and has a first portion formed with a first arm 221 and a second portion formed with a second arm 222.

The cutting device 20 further comprises a first pivot shaft 223 extended through the fixing seat 21 and a bent mediate portion of the crank axle 22, so that the crank axle 22 is pivotally mounted on the fixing seat 21.

The drive unit 23 is mounted on the crank axle 22 and includes a first roller 231 mounted on a first end of the first pivot shaft 223 and rested on the bent mediate portion of the crank axle 22, a second roller 232 rotatably mounted on the first arm 221 of the crank axle 22 by a second pivot shaft 236, a third roller 233 rotatably mounted on the first arm 221 of the crank axle 22 by a first end of a third pivot shaft 237, a fourth roller 234 rotatably mounted on the first arm 221 of the crank axle 22 by a fourth pivot shaft 238, and a drive belt 235 mounted between the first roller 231, the second roller 232, the third roller 233 and the fourth roller 234. Preferably, the second roller 232 is located between the first roller 231 and the third roller 233, and the third roller 233 is located between the second roller 232 and the fourth roller 234. The second roller 232 functions as an idler, and the second pivot shaft 236 has an eccentric structure, so that the second roller 232 is moved relative to the drive belt 235 by rotation of the second pivot shaft 236 to adjust the tension between the second roller 232 and the drive belt 235.

The first saw blade 24 is mounted on a second end of the first pivot shaft 223.

The second saw blade 25 is mounted on a second end of the third pivot shaft 237. The third pivot shaft 237 does not pass through the fixing seat 21.

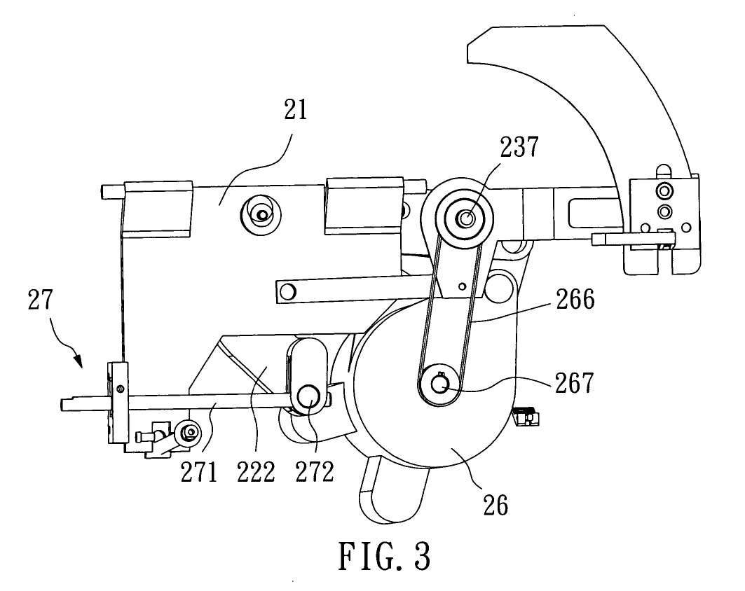

The motor 26 is mounted on the crank axle 22 and has an end provided with a first connecting plate 261 pivotally mounted on the first arm 221 of the crank axle 22 by a fixing shaft 263 and a second connecting plate 262 movably mounted on the crank axle 22. The second connecting plate 262 of the motor 26 is formed with an arcuate elongated guide slot 264, and a screw member 265 is extended through the guide slot 264 of the second connecting plate 262 of the motor 26 and is screwed into the crank axle 22. As shown in FIG. 3, the motor 26 has an output end 267, and a belt 266 is mounted on the output end 267 of the motor 26 and the third pivot shaft 237.

As shown in FIGS. 1 and 3, the adjusting unit 27 is mounted between the fixing seat 21 and the crank axle 22 and includes an adjusting block 272 secured on the second arm 222 of the crank axle 22 and formed with a screw bore 273, and a threaded rod 271 having a first end secured on the fixing seat 21 and a threaded second end screwed into the screw bore 273 of the adjusting block 272.

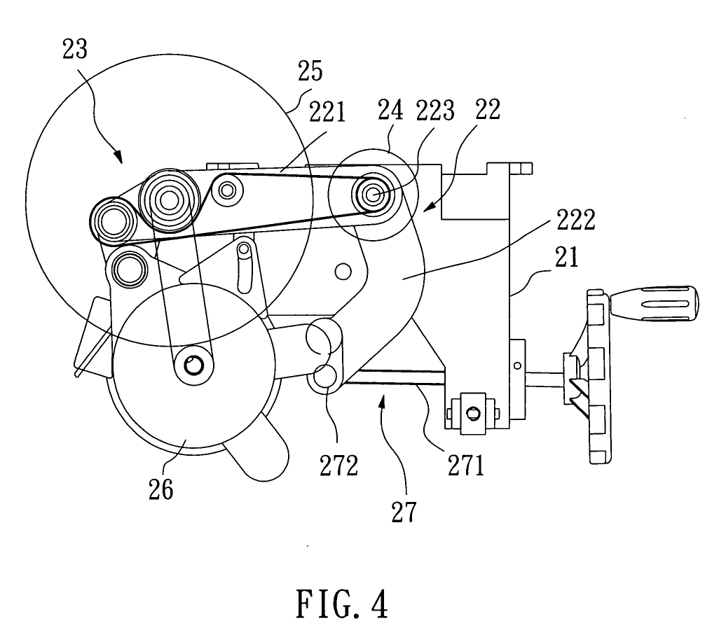

As shown in FIG. 4, the second saw blade 25 is located at a higher position.

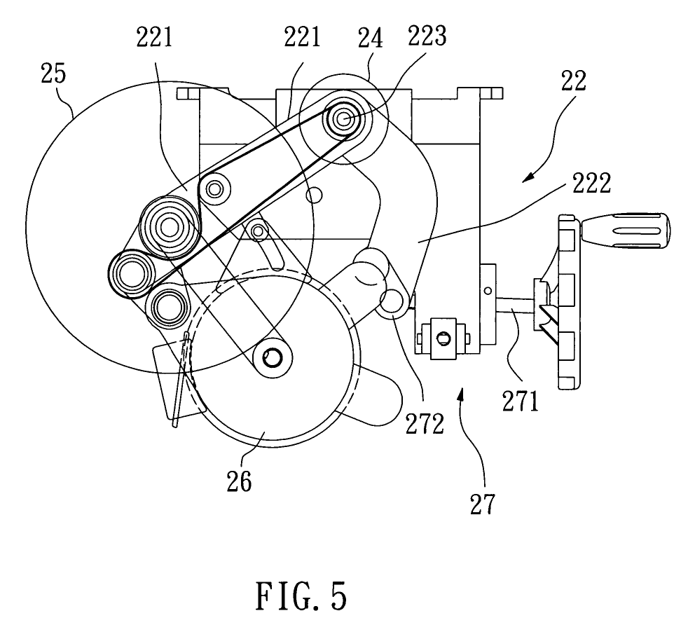

As shown in FIG. 5, when the threaded rod 271 is rotated on the fixing seat 21, the threaded second end of the threaded rod 271 is screwed into the screw bore 273 of the adjusting block 272 successively to move the adjusting block 272 relative to the threaded rod 271, so that the second arm 222 of the crank axle 22 is pulled by the adjusting block 272 to move toward the threaded rod 271, and the crank axle 22 is pivoted about the first pivot shaft 223. Thus, the first arm 221 of the crank axle 22 is moved downward, so that the third pivot shaft 237 is moved downward, thereby lowering the second saw blade 25, and thereby changing the position of the motor 26.

In such a manner, as shown in FIGS. 4 and 5, the threaded rod 271 co-operates with the adjusting block 272 to drive the crank axle 22 to pivot about the first pivot shaft 223, so that the second saw blade 25 is moved downward or upward, thereby adjusting the height of the second saw blade 25.

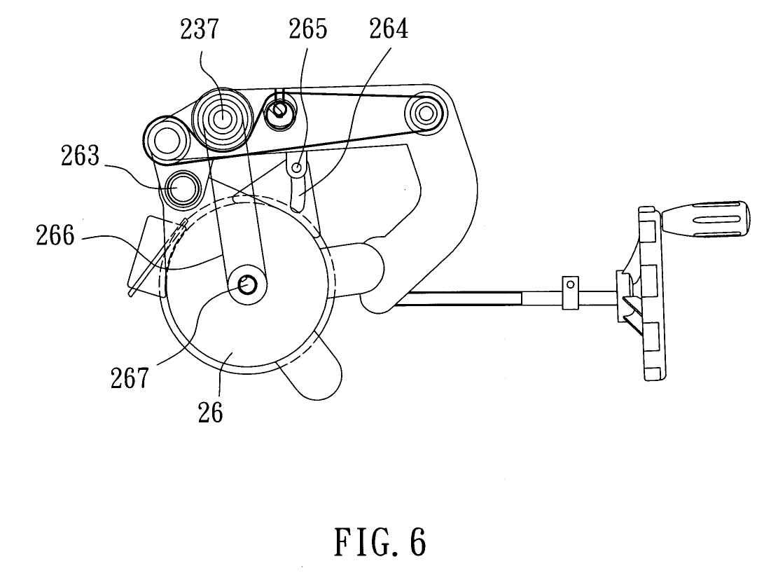

As shown in FIG. 6, the screw member 265 is located at an uppermost position of the guide slot 264 of the second connecting plate 262 of the motor 26, and the belt 266 is tightly stretched between the output end 267 of the motor 26 and the third pivot shaft 237 so as to transmit the power of the motor 26 to the third pivot shaft 237 and the third roller 233.

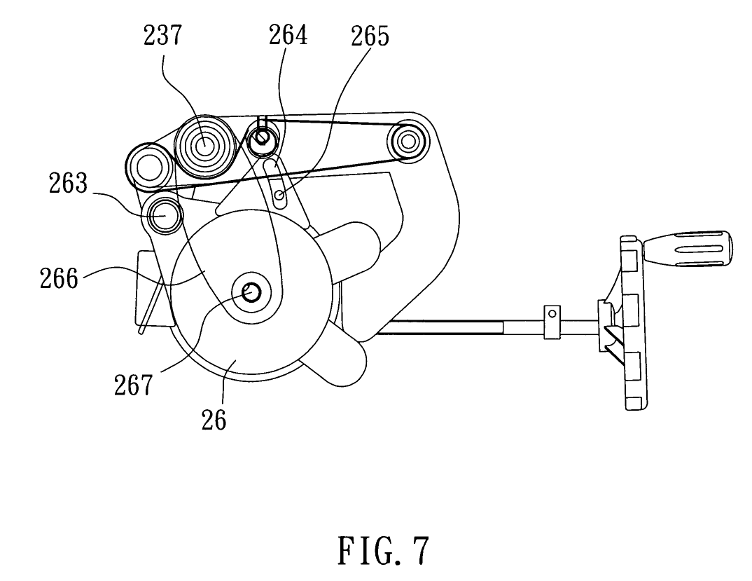

As shown in FIG. 7, the screw member 265 is unscrewed from the crank axle 22 to release the second connecting plate 262 of the motor 26, so that the motor 26 can be moved upward relative to the crank axle 22 about the fixing shaft 263 until the screw member 265 is located at a lowermost position of the guide slot 264 of the second connecting plate 26 of the motor 26. At this time, the distance between the output end 267 of the motor 26 and the third pivot shaft 237 is reduced, so that the belt 266 can be removed from the output end 267 of the motor 26 and the third pivot shaft 237 so as to facilitate the user replacing the belt 266.

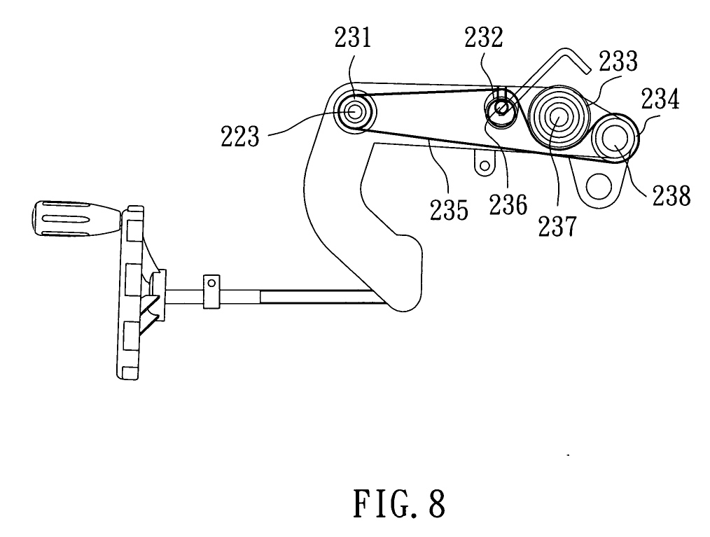

As shown in FIG. 8, the drive belt 235 is tightly stretched between the first roller 231, the second roller 232, the third roller 233 and the fourth roller 234 to transmit the power.

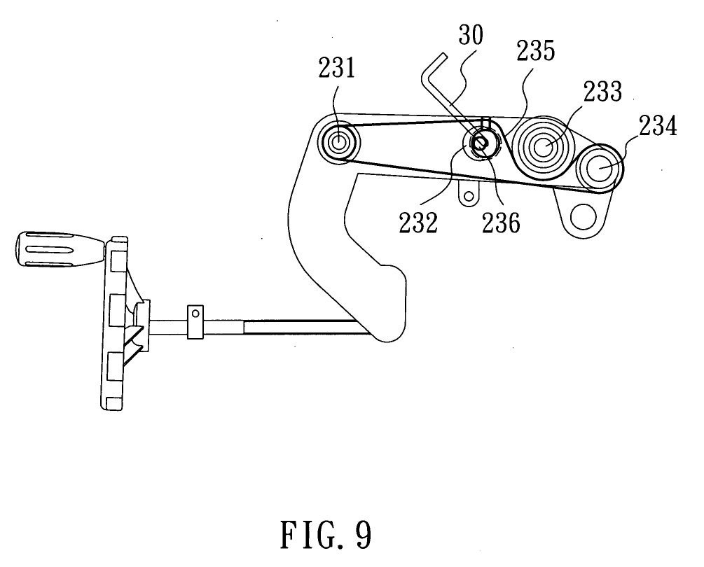

As shown in FIG. 9, when the second pivot shaft 236 is rotated by a tool 30, such as a hex wrench, the second pivot shaft 236 has an eccentric structure, so that the second roller 232 mounted on the second pivot shaft 236 is driven to move relative to the drive belt 235 by rotation of the second pivot shaft 236, thereby detaching the second roller 232 from the drive belt 235 so as to facilitate the user replacing the drive belt 235.

Accordingly, the adjusting unit 27 is operated to drive the crank axle 22 to pivot, so that the second saw blade 25 mounted on the crank axle 22 is moved downward or upward, thereby adjusting the height of the second saw blade 25 relative to the first saw blade 24 so as to fit workpieces of different thickness. In addition, the motor 26 can be moved relative to the crank axle 22, so that the belt 266 mounted on the motor 26 can be loosened and removed from the output end 267 of the motor 26, thereby facilitating the user replacing the belt 266. Further, the second pivot shaft 236 has an eccentric structure, so that the second roller 232 mounted on the second pivot shaft 236 is driven to move relative to the drive belt 235 by rotation of the second pivot shaft 236, thereby detaching the second roller 232 from the drive belt 235, thereby facilitating the user replacing the drive belt 235.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A cutting device, comprising:
a fixing seat;
a crank axle pivotally mounted on the fixing seat by a pivot shaft;
a first saw blade mounted on the pivot shaft;
a second saw blade mounted on the crank axle to move therewith;
a motor mounted on the crank axle; and
an adjusting unit mounted between the fixing seat and the crank axle to drive the crank axle to pivot about the pivot shaft and to move relative to the fixing seat.

2. The cutting device in accordance with claim 1, wherein the adjusting unit includes an adjusting block secured on an end of the crank axle and formed with a screw bore, and a threaded rod having a first end secured on the fixing seat and a threaded second end screwed into the screw bore of the adjusting block.

3. The cutting device in accordance with claim 1, wherein the crank axle has a first portion formed with a first arm, a bent mediate portion pivotally mounted on the pivot shaft and a second portion formed with a second arm.

4. The cutting device in accordance with claim 1, wherein the crank axle is substantially L-shaped.

5. The cutting device in accordance with claim 1, wherein the motor is pivotally mounted on and movable relative to the crank axle.

6. The cutting device in accordance with claim 1, wherein the motor has an end provided with a first connecting plate pivotally mounted on the crank axle by a fixing shaft and a second connecting plate movably mounted on the crank axle.

7. The cutting device in accordance with claim 6, wherein the second connecting plate of the motor is formed with an arcuate elongated guide slot, and the cutting device further comprises a screw member extended through the guide slot of the second connecting plate of the motor and screwed into the crank axle.

8. The cutting device in accordance with claim 1, further comprising a drive unit mounted on the crank axle and including a plurality of rollers rotatably mounted on the crank axle respectively, and a drive belt mounted between the rollers.

9. The cutting device in accordance with claim 8, wherein one of the rollers is driven by the motor to rotate.

10. The cutting device in accordance with claim 8, wherein one of the rollers is mounted on the pivot shaft.

11. The cutting device in accordance with claim 8, wherein one of the rollers is rotatably mounted on an end of the crank axle by a pivot shaft.

12. The cutting device in accordance with claim 11, wherein the second pivot shaft has an eccentric structure, so that the roller mounted on the second pivot shaft is moved relative to the drive belt by rotation of the second pivot shaft.

13. The cutting device in accordance with claim 11, wherein the roller mounted on the second pivot shaft functions as an idler.

14. The cutting device in accordance with claim 8, wherein the second saw blade and one of the rollers are mounted on a pivot shaft.

15. The cutting device in accordance with claim 14, wherein the motor has an output end, and a belt is mounted on the output end of the motor and the pivot shaft.
